(19) United States
(12) Patent Application Publication
(10) Pub. No.: US 2026/0341754 A1
(43) Pub. Date: Oct. 29, 2026

(54) METHOD FOR DETERMINING INFORMATION ABOUT AT LEAST ONE STACK PORTION OF A FUEL CELL STACK, AND VEHICLE

(71) Applicant: Robert Bosch GmbH, Stuttgart (DE)

(72) Inventors: Ulrich Berner, Stuttgart (DE); Christophe Gerling, Köngen (DE); Jochen Wessner, Esslingen (DE); Juergen Hackenberg, Sachsenheim (DE); Michael Giuseppe Marino, Linz (AT); Ulrich Sauter, Karlsruhe (DE)

(21) Appl. No.: 19/140,422

(22) PCT Filed: Dec. 15, 2023
(86) PCT No.: PCT/EP2023/086074

§ 371 Date: Jun. 18, 2025

(30) Foreign Application Priority Data
Dec. 19, 2022 (DE) 10 2022 213 876.7

(51) Int. Cl. H01M 8/04303; H01M 8/04302; H01M 8/0432; H01M 8/04492; H01M 8/04537; H01M 8/04791

(52) U.S. Cl. CPC H01M 8/04303; H01M 8/04302; H01M 8/04358; H01M 8/04492; H01M 8/04559; H01M 8/04619; H01M 8/04649; H01M 8/04798; H01M 2250/20

(57) ABSTRACT

A method for determining information about a fuel cell stack (100) of a vehicle (200) after a switch-off. The method comprises as one step, detecting (320) a switch-off command, and as one step, closing (341) a cathode gas inlet valve and closing (342) a cathode gas outlet valve in order to fluidically block off a cathode region (K). The method further comprises, as one step, applying (360) an electrical load device (230) to the fuel cell stack (100) until a predefined target voltage is detected (370), and as one step, closing (381) an anode gas inlet valve and closing (382) an anode gas outlet valve in order to fluidically block off an anode region (A). The method further comprises, as one step, applying (400) an electrical measurement signal to the fuel cell stack (100), and as a further step, detecting (420) a signal response. The method further comprises, as one step, determining (440) information at least about the at least one stack portion of the fuel cell stack (100) of the fuel cell system (210) based on the applied measurement signal and the detected signal response.

### BACKGROUND

Fuel cells are electrochemical energy converters used, for example, to convert hydrogen and oxygen into water, electrical energy, and heat.

Impedance measurements may be used to obtain information about electrical or electrochemical states/properties of a fuel cell.

### SUMMARY

The present invention shows a method for determining information about at least one stack portion of a fuel cell stack of a fuel cell system of a vehicle after a switch-off of the vehicle according to the disclosure, a vehicle according to the disclosure, a computer program product according to the disclosure, a computer-readable medium according to the disclosure and a data carrier signal according to the disclosure.

Further features and details of the invention arise from the dependent claims, the description, and the drawings. In this context, features and details described in connection with the method according to the invention clearly also apply in connection with the vehicle according to the invention, the computer program product according to the invention, the computer-readable medium according to the invention and the data carrier signal according to the invention and respectively vice versa so that, with respect to the disclosure, mutual reference to the individual aspects of the invention is or can always be made.

According to a first aspect, the present invention shows a method for determining information about at least one stack portion of a fuel cell stack of a fuel cell system of a vehicle after a switch-off of the vehicle. The method comprises, as one step, detecting a switch-off command for switching off the vehicle. Furthermore, as one step, the method comprises closing a cathode gas inlet valve of the fuel cell system and closing a cathode gas outlet valve of the fuel cell system in order to fluidically block off a cathode region of the fuel cell stack with an air mixture present in the cathode region when the switch-off command is detected. The method further comprises one step for applying an electrical load device at least to the at least one stack portion of the fuel cell stack in order to reduce the portion of oxygen in the air mixture in the blocked-off cathode region of the fuel cell stack, wherein the load device is applied at least until a predefined target voltage is detected. Furthermore, the method comprises one step for closing an anode gas inlet valve of the fuel cell system and closing an anode gas outlet valve of the fuel cell system in order to fluidically block off an anode region of the fuel cell stack having a fuel mixture present in the anode region when the predefined target voltage is detected. Furthermore, the method comprises one step for applying an electrical measurement signal at least to the at least one stack portion of the fuel cell stack, particularly when the anode gas inlet valve and the anode gas outlet valve are closed. Furthermore, the method comprises one step for detecting a signal response to the applied electrical measurement signal. Furthermore, the method comprises, as one step, determining information at least about the at least one stack portion of the fuel cell stack of the fuel cell system based on the applied measurement signal and the detected signal response.

The method steps described above and below can be performed individually, together, once, several times, in parallel, and/or consecutively in any order, provided that doing so is technically feasible.

The vehicle is in particular a motor vehicle, preferably a passenger car or a truck.

The stack portion of the fuel cell stack can be one fuel cell of the fuel cell stack or the stack portion of the fuel cell stack can be several fuel cells of the fuel cell stack, in particular several electrically series-connected fuel cells of the fuel cell stack.

The fuel cell stack itself may comprise a plurality of fuel cells. In particular, the fuel cell stack may be a polymer electrolyte membrane fuel cell stack and may preferably be operated with air and a fuel, particularly hydrogen.

Switching off the vehicle may also be understood as shutting down the vehicle. In particular, in the switched off state, the vehicle cannot be driven by means of a drive unit, for example a motor, such as an electric motor. For example, a driver of the vehicle may switch off the vehicle by way of a switch-off button and/or by way of a vehicle key. Alternatively or additionally, it is also contemplated that the vehicle switches itself off if at least one condition is met. One example of this is a vehicle start/stop function.

The detection of the switch-off command for the switch-off of the vehicle may be detected, for example, by a control device, in particular a control unit, of the vehicle.

The cathode inlet valve and/or the cathode outlet valve and/or the anode gas inlet valve and/or the anode gas outlet valve are arranged particularly near the fuel cell stack of the fuel cell system and/or directly on the fuel cell stack. For example, the cathode inlet valve and/or the cathode outlet valve and/or the anode gas inlet valve and/or the anode gas outlet valve are arranged at a distance from the fuel cell stack of the fuel cell system in a range of 1 to 100 cm, in particular in a range of 5 to 50 cm.

The cathode region is in particular the fluid space that is formed between the cathode inlet valve, the fuel cell stack and the cathode outlet valve. The anode area is in particular the fluid space that is formed between the anode inlet valve, the fuel cell stack and the anode outlet valve.

The electrical load device may be, for example, an electrical consumer of the vehicle. In particular, the electrical load device is a variable load device. In other words, the electrical load provided by the electrical load device may be varied. In particular, the electrical load of the variable load device may be adjusted as a function of a detected voltage across the fuel cell stack. Preferably, the electrical load of the variable load device is reduced at least once as the detected voltage across the fuel cell stack decreases. Thus, reducing oxygen in the cathode region of the fuel cell stack may be particularly advantageous.

Furthermore, a voltage across the fuel cell stack or across the at least one stack portion of the fuel cell stack is detected in particular in order to recognize when a predefined target voltage across the fuel cell stack and/or across the at least one stack portion of the fuel cell stack has been reached. The voltage can be detected using a voltmeter, for example.

For example, the target voltage for a single fuel cell of the fuel cell stack may be approximately 50 mV, in particular approximately 30 mV. If the voltage for detecting the target voltage is detected via the (complete) fuel cell stack or a plurality of fuel cells, the target voltage is in particular a correspondingly multiple thereof. With such a target voltage, it can in particular be assumed that the oxygen on the cathode side or in the cathode region of the fuel cell stack is consumed or substantially consumed.

The electrical measurement signal is in particular a voltage measurement signal, wherein in particular a current signal response is detected as a signal response to the applied voltage measurement signal.

It is also contemplated that the electrical measurement signal is in particular a current measurement signal, wherein in particular a voltage signal response is detected as a signal response to the applied current measurement signal.

The application of the electrical measurement signal is in particular carried out by means of an application device. Furthermore, the detection of the signal response in particular is carried out by means of a detection device. In addition, the determination of information in particular is carried out at least via the at least one stack portion of the fuel cell stack of the fuel cell system by means of a determination device.

The information about the at least one stack portion of the fuel cell stack or the fuel cell stack may include, for example, information about a moisture state of the fuel cell stack or a component or multiple components of the fuel cell stack and/or information about an aging state of the fuel cell stack or a component or multiple components of the fuel cell stack and/or information about an electrically resistive state of the fuel cell stack or a component or multiple components of the fuel cell stack.

By closing the cathode inlet valve and the cathode outlet valve after the switch-off of the vehicle, then applying an electrical load device until a predefined target voltage is reached, and then closing the anode inlet valve and the anode outlet valve, the fuel cells of the fuel cell stack or the fuel cell stacks can be brought to a defined state. The defined state is in particular a hydrogen/nitrogen state (H2/N2 state). Thus, information regarding ohmic resistances and a state of an ionomer in the cathode of the fuel cell stack in particular can be obtained because the oxygen is consumed or substantially consumed (i.e., plays no or only a minor role).

It may be advantageous if, in a method according to the invention, a measurement signal is applied with a varying frequency in order to determine at least a plurality of impedance values, wherein in particular a measurement signal with a frequency varying between 100 kHz to 1 Hz, preferably between 50 kHz and 100 Hz, varying frequency is applied. Thus, information about the at least one stack portion of the fuel cell stack of the fuel cell system may be obtained particularly easily. It is contemplated that the measurement signal is only applied for a plurality of frequencies and in particular an interpolation and/or extrapolation, e.g., by means of a control unit of the vehicle, is performed. Thus, determining information about the at least one stack portion of the fuel cell stack of the fuel cell system may be obtained particularly quickly. It may be advantageous if, in a method according to the invention, ohmic losses and/or a proton conducting resistance of the at least one stack portion of the fuel cell stack of the fuel cell system are determined from the determined impedance values. The ohmic losses can be obtained, for example, from a zero pass of an impedance curve (Nyquist plotting) resulting from the determined impedance values. The proton conducting resistance can be obtained, for example, from a slope. Thus, information about the at least one stack portion of the fuel cell stack of the fuel cell system may be obtained particularly easily. From the ohmic losses in particular, a membrane state, for example a moisture of a membrane or a plurality of membranes, and/or an electrically resistive state, for example a contact resistance, can be determined from the ohmic losses as information at least about the at least one stack portion of the fuel cell stack of the fuel cell system. Alternatively or additionally, a moisture state of an electrode or a plurality of electrodes and/or a chemical degradation state of an ionomer or a plurality of ionomers can be determined from the proton conducting resistance as information at least about the at least one stack portion of the fuel cell stack of the fuel cell system.

It may be advantageous if, in a method according to the invention, at least one temperature of the fuel cell stack is detected and stored for a specific time range at a time before the vehicle is switched off and/or that a power called up by the fuel cell stack is detected and stored for a specific time range at a time before the vehicle is switched off, wherein the detected temperature of the fuel cell stack and/or the detected called-up power of the fuel cell stack is taken into account for determining the information at least about the at least one stack portion of the fuel cell stack of the fuel cell system. Thus, the determination of information about the at least one stack portion of the fuel cell stack of the fuel cell system may be particularly accurate and may occur as a function of the state of the fuel cell stack shortly prior to the switch-off of the vehicle. For example, at least one temperature, e.g., a temperature of a coolant, of the fuel cell stack can be detected and stored in a memory of the vehicle for a time range of 2 to 20 minutes, in particular for a time range of 5 to 15 minutes, before the switch-off of the vehicle, and/or a power called up by the fuel cell stack can be detected and stored. In particular, before switching off, the vehicle is in a driving mode in which the vehicle moves or can move by means of a drive unit of the vehicle, e.g., by pressing an accelerator pedal. To take into account the detected temperature and/or the called-up power for determining the information at least about the at least one stack portion of the fuel cell stack, reference data, for example, is stored in the vehicle and/or in a cloud. This takes into account an impact of the temperature and/or the called-up power prior to the switch-off of the vehicle when determining the information.

It may be advantageous if, in a method according to the invention, after the vehicle has been switched off, the method is carried out several times in succession in a continuous switch-off state of the vehicle, in particular is carried out several times in succession at specific time intervals. Thus, a progression of the information about the at least one stack portion of the fuel cell stack of the fuel cell system over time can be viewed and, if necessary, further information can be obtained therefrom. It is contemplated that after the switch-off of the vehicle, the method according to the invention is carried out at a certain time interval, e.g., every 5 min. If, during the performance of the method according to the invention, a switch-on command for switching on the vehicle is detected, e.g., by the detection device, the method according to the invention is preferably canceled as a function of an expected remaining time. Thus, a driver of the vehicle is spared having to wait for the termination of the method with an expected long remaining time, e.g., a remaining time of more than 5 seconds.

It may be advantageous if, in a method according to the invention, reference data is stored in the vehicle and/or that reference data is stored in a cloud, wherein the reference data is used for determining information at least about the at least one stack portion of the fuel cell stack of the fuel cell system (based on the applied measurement signal and the detected signal response). By storing reference data in the vehicle itself, information about the at least one stack portion of the fuel cell stack of the fuel cell system may be obtained particularly easily. For example, the reference data may be stored in a memory, in particular a non-volatile memory, of the vehicle. By storing reference data in the cloud, the reference data can be kept particularly simply up-to-date and information about the at least one stack portion of the fuel cell stack of the fuel cell system can thus be particularly accurate. The cloud may also be understood as a data cloud. The reference data can, for example, have impedance values and/or impedance curves.

It may be advantageous if, in a method according to the invention, information about the complete fuel cell stack of the fuel cell system is determined based on the applied measurement signal, and the detected signal response, and/or information is determined for a plurality of stack portions of the fuel cell stack of the fuel cell system in each case based on a respective applied measurement signal and a respective detected signal response. By determining information about the complete fuel cell stack of the fuel cell system, an overall statement of the state of the fuel cell stack may be made. Determining information about the complete fuel cell stack of the fuel cell system may advantageously be particularly fast because information is not obtained for each of the multiple stack portions of the fuel cell stack of the fuel cell system.

By respectively determining information for a plurality of stack portions of the fuel cell stack of the fuel cell system based on a respective applied measurement signal, as well as a respective detected signal response, a respective stack portion of the plurality of stack portions of the fuel cell stack may specifically be made, for example, a respective statement about the state of a respective stack portion of the plurality of stack portions.

It may be advantageous if, in a method according to the invention, an occupant of the vehicle is shown indications as a function of the determined information. For example, the occupant of the vehicle may be indicated that the fuel cell system or stack of fuel cells is OK and the occupant may travel with piece of mind. It is also conceivable that if the fuel cell stack is in a critical state, the occupant of the vehicle is shown an indication that they should take a certain action, e.g., visit a workshop. The occupant of the vehicle is particularly to be understood as the driver of the vehicle.

It may be advantageous if, in a method according to the invention, the information determined after the vehicle has been switched off is taken into account when the vehicle is switched on for starting up the fuel cell system, wherein, in particular for taking into account the determined information for starting up the fuel cell system, a start-up sequence of the fuel cell system is determined on the basis of the determined information. Thus, a deterioration of the fuel cell system or the fuel cell stack can be particularly advantageously kept to a low level. If, for example, it is determined as information by the method according to the invention that the moist state of an electrode or a plurality of electrodes of the fuel cell stack is too low, countermeasures can be taken at a next switch-on. A corresponding start-up procedure can be determined, for example, as a function of reference data stored, for example, in the vehicle and/or on a cloud.

According to a second aspect, the present invention shows a vehicle, wherein the vehicle is configured to perform a method according to the present invention for determining information about at least one stack portion of a fuel cell stack of a fuel cell system of the vehicle after a switch-off of the vehicle. The vehicle comprises a detection device for detecting a switch-off command for switching off the vehicle. Furthermore. the vehicle comprises a fuel cell system having a fuel cell stack, wherein a cathode region of the fuel cell stack can be fluidically blocked off by means of a cathode gas inlet valve and a cathode gas outlet valve, and wherein an anode region of the fuel cell stack can be fluidically blocked off by means of anode gas inlet valve and an anode gas outlet valve. Furthermore. the vehicle comprises an electrical load device which can be applied to at least one stack portion of the fuel cell stack. Furthermore. the vehicle comprises an application device for applying an electrical measurement signal to at least one stack portion of the fuel cell stack. Furthermore. the vehicle comprises a detection device for detecting a signal response to the applied electrical measurement signal. Furthermore, the vehicle comprises a determination device for determining information at least about the at least one stack portion of the fuel cell stack of the fuel cell system based on the applied measurement signal and the detected signal response.

Preferably, means or devices already required for the operation of the fuel cell system, for example a control unit, are used to perform the method according to the invention.

Furthermore, the vehicle comprises in particular a voltage detection device or a voltmeter for detecting a voltage across the fuel cell stack and/or across the at least one stack portion of the fuel cell stack in order to be able to recognize when a predefined target voltage across the fuel cell stack and/or across the at least one stack portion of the fuel cell stack has been reached. The recognition that a predefined target voltage is achieved can occur, for example, by means of a control device.

The vehicle according to the second aspect of the invention thus has the same advantages as have already been described for the method according to the first aspect of the invention.

According to a third aspect, the present invention shows a computer program product comprising instructions that cause a vehicle, in particular a vehicle according to the invention, to perform method steps according to a method according to the invention.

The computer program product may be implemented as a computer-readable instruction code. The computer program product may further be realized at least in part by software, as well as by one or more specific electronic circuits, i.e., in hardware or in any hybrid form, i.e., by means of software components and hardware components.

The computer program product according to the third aspect of the invention thus has the same advantages as have already been described for the method according to the first aspect of the invention or the vehicle according to the second aspect of the invention.

According to a fourth aspect, the present invention shows a computer-readable medium having stored thereon a computer program product according to the present invention.

In particular, the computer program product may be stored on a computer-readable storage medium such as a data disc, removable drive, volatile or non-volatile memory, or a built-in memory/processor.

The computer-readable medium according to the third aspect of the invention thus has the same advantages as have already been described for the method according to the first aspect of the invention or the vehicle according to the second aspect of the invention or the computer program product according to the third aspect of the invention.

According to a fifth aspect, the present invention shows a data carrier signal transmitting a computer program product according to the present invention.

In particular, the computer program product may be available or deployed on a network such as the Internet, from which it may be downloaded as needed by a user or executed online.

The data carrier signal according to the fifth aspect of the invention thus has the same advantages as have already been described for the method according to the first aspect of the invention or the vehicle according to the second aspect of the invention or the computer program product according to the third aspect of the invention or the computer-readable medium according to the fourth aspect of the invention.

### BRIEF DESCRIPTION OF THE DRAWINGS

Further measures improving the invention arise from the following description of a few exemplary embodiments of the invention, which are schematically represented in the figures. All of the features and/or advantages arising from the claims, description, or drawings, including structural details, spatial arrangements, and method steps, can be essential to the invention both by themselves and in the various combinations. It should be noted that the figures have only a descriptive character and are not intended to limit the invention in any way.

Schematically shown are:

FIG. 1 a method, and

FIG. 2 a vehicle.

### DETAILED DESCRIPTION

In the following figures, identical reference numbers are used for identical technical features, even in different exemplary embodiments.

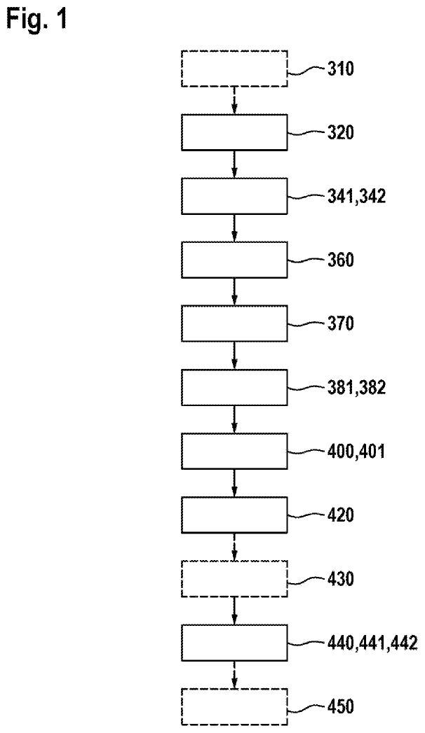

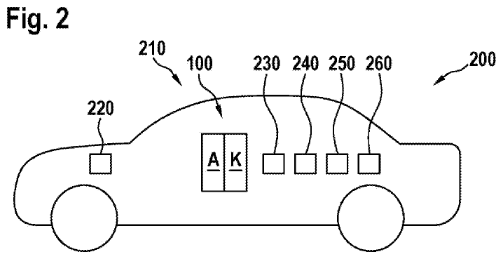

FIG. 1 discloses a method for determining information about at least one stack portion of a fuel cell stack 100 of a fuel cell system 210 of a vehicle 200 after a switch-off of the vehicle 200 (see, for example, in this regard. FIG. 2). The method comprises, as one step, detecting 320 a switch-off command for switching off the vehicle 200. Furthermore, as one step, the method comprises closing 341, in particular completely closing, a cathode gas inlet valve of the fuel cell system 210 and closing 342, in particular completely closing, a cathode gas outlet valve of the fuel cell system 210 in order to fluidically block off a cathode region K of the fuel cell stack 100 with an air mixture present in the cathode region K when the switch-off command is detected. The method further comprises one step for applying 360 an electrical load device 230 or an electrical consumer at least to the at least one stack portion of the fuel cell stack 100 in order to reduce the portion of oxygen in the air mixture in the blocked-off cathode region K of the fuel cell stack 100, wherein the load device 230 is applied at least until a predefined target voltage is detected 370. Furthermore, the method comprises one step for closing 381, in particular completely closing, an anode gas inlet valve of the fuel cell system 210 and closing 382, in particular completely closing, an anode gas outlet valve of the fuel cell system 210 in order to fluidically block off an anode region A of the fuel cell stack 100 having a fuel mixture present in the anode region A when the predefined target voltage is detected. Furthermore, the method comprises one step for applying 400 an electrical measurement signal or a voltage measurement signal, and/or a current measurement signal at least to the at least one stack portion of the fuel cell stack 100, particularly when the anode gas inlet valve and the anode gas outlet valve are closed. Furthermore, the method comprises one step for detecting 420 a signal response to the applied electrical measurement signal. The method further comprises, as one step, determining 440 information at least about the at least one stack portion of the fuel cell stack 100 of the fuel cell system 210 based on the applied measurement signal and the detected signal response or by a comparison with reference data. In particular, the information determined after the switch-off of the vehicle 200 can be taken into account when the vehicle 200 is switched on for starting up the fuel cell system 210, wherein, in particular for taking into account the determined information for starting up the fuel cell system 210, a start-up sequence of the fuel cell system 210 is determined on the basis of the determined information.

It may be advantageous if, in the method in particular, a measurement signal is applied 401 with a varying frequency to determine at least a plurality of impedance values, wherein in particular a measurement signal with a frequency varying between 100 kHz to 1 Hz, preferably between 50 kHz and 100 Hz, varying frequency is applied 401. It may be advantageous if, in the method, ohmic losses and/or a proton conducting resistance of the at least one stack portion of the fuel cell stack 100 of the fuel cell system 210 are determined 430 from the determined impedance values. From the (determined) ohmic losses, a membrane state and/or an electrically resistive state may be determined 440 as information about at least one stack portion of the fuel cell stack 100 of the fuel cell system 210, for example, by comparing the (determined) ohmic losses with reference data. Alternatively or additionally, it is also contemplated that a moisture state of an electrode or multiple electrodes of the fuel cell stack and/or a chemical degradation state of an ionomer or multiple ionomers of the fuel cell stack are determined 440 from the (averaged) proton conducting resistor as information at least about the one stack portion of the fuel cell stack 100 of the fuel cell system 210, by comparing the (determined) proton conducting resistance with reference data, for example.

It may also be advantageous if, in the method in particular, at least one temperature of the fuel cell stack 100 is detected and stored 310 for a specific time range (directly before switch-off) at a time before the switch-off of the vehicle 200 and/or that a power called up by the fuel cell stack 100 is detected and stored 310 (directly before switch-off) for a specific time range at a time before the switch-off of the vehicle 200, wherein the detected temperature of the fuel cell stack 100 and/or the detected called-up power of the fuel cell stack 100 is taken into account for determining the information at least about the at least one stack portion of the fuel cell stack 100 of the fuel cell system 210.

It may also be advantageous if, in the method, after the vehicle 200 has been switched off, the method is carried out several times in succession in a continuous switch-off state of the vehicle 200, in particular is carried out several times in succession at specific time intervals.

It may also be advantageous if, in the method, reference data in particular is stored in the vehicle 200 and/or reference data is stored in a cloud, wherein the reference data is used for determining information at least about the at least one stack portion of the fuel cell stack 100 of the fuel cell system 210 based on the applied measurement signal and the detected signal response.

It may also be advantageous if, in the method in particular, information about the complete fuel cell stack 100 of the fuel cell system 210, i.e., in particular via the fuel cell stack 100 as a whole, is determined 441 based on the applied measurement signal, and the detected signal response, and/or information is determined 442 for a plurality of stack portions of the fuel cell stack 100 of the fuel cell system 210 in each case based on a respective applied measurement signal and a respective detected signal response.

It may also be advantageous if, in the method, an occupant of the vehicle 200 is shown 450 indications as a function of the determined information.

FIG. 2 discloses a method 200, wherein the vehicle 200 is configured to perform a method according to the invention (see, for example, in this regard. FIG. 1). for determining information about at least one stack portion of a fuel cell stack 100 of a fuel cell system 210 of the vehicle 200 after a switch-off of the vehicle 200. The vehicle 200 comprises a detection device 220 for detecting a switch-off command for switching off the vehicle 200. Furthermore. the vehicle 200 comprises a fuel cell system 210 (for the sake of clarity, only the fuel cell stack 100 is shown) having a fuel cell stack 100, wherein a cathode region K of the fuel cell stack 100 can be fluidically blocked off by means of a cathode gas inlet valve and a cathode gas outlet valve, and wherein an anode region A of the fuel cell stack 100 can be fluidically blocked off by means of anode gas inlet valve and an anode gas outlet valve. Furthermore, the vehicle 200 comprises an electrical load device 230 that can be applied to the at least one stack portion of the fuel cell stack 100 such that electrical power or energy can be called up by the fuel cell stack 100. Furthermore. the vehicle 200 comprises an (electrical) application device 240 for applying an electrical measurement signal to the at least one stack portion of the fuel cell stack 100.

Furthermore. the vehicle 200 comprises a detection device 250 for detecting a signal response to the applied electrical measurement signal. Furthermore, the vehicle 200 comprises a determination device 260 for determining information at least about the at least one stack portion of the fuel cell stack 100 of the fuel cell system 210 based on the applied measurement signal and the detected signal response.

1. A method for determining information about at least one stack portion of a fuel cell stack (100) of a fuel cell system (210) of a vehicle (200) after a switch-off of the vehicle (200), the method comprising:
detecting (320) a switch-off command for switching off the vehicle (200),
closing (341) a cathode gas inlet valve of the fuel cell system (210) and closing (342) a cathode gas outlet valve of the fuel cell system (210) in order to fluidically block off a cathode region (K) of the fuel cell stack (100) with an air mixture present in the cathode region (K) when the switch-off command is detected,
applying (360) an electrical load device (230) at least to the at least one stack portion of the fuel cell stack (100) in order to reduce the portion of oxygen in the air mixture in the blocked-off cathode region (K) of the fuel cell stack (100), wherein the load device (230) is applied at least until a predefined target voltage is detected (370),
closing (381) an anode gas inlet valve of the fuel cell system (210) and closing (382) an anode gas outlet valve of the fuel cell system (210) in order to fluidically block off an anode region (A) of the fuel cell stack (100) having a fuel mixture present in the anode region (A) when the predefined target voltage is detected,
applying (400) an electrical measurement signal at least to the at least one stack portion of the fuel cell stack (100),
detecting (420) a signal response to the applied electrical measurement signal, and
determining (440) information at least about the at least one stack portion of the fuel cell stack (100) of the fuel cell system (210) based on the applied measurement signal and the detected signal response.

2. The method according to claim 1,
wherein
a measurement signal is applied (401) with a varying frequency to determine at least a plurality of impedance values, wherein a measurement signal with a frequency varying between 100 kHz to 1 Hz, applied (401).

3. The method according to claim 2,
wherein
ohmic losses and/or a proton conducting resistance of the at least one stack portion of the fuel cell stack (100) of the fuel cell system (210) are determined (430) from the determined impedance values,
and wherein, from the ohmic losses, a membrane state and/or an electrical resistance state are determined (440) as information at least about the at least one stack portion of the fuel cell stack (100) of the fuel cell system (210)
and/or, wherein a moisture state of an electrode and/or a chemical degradation state of an ionomer are determined (440) from the proton conducting resistance as information at least about the at least one stack portion of the fuel cell stack (100) of the fuel cell system (210).

4. The method according to claim 1,
wherein
at least one temperature of the fuel cell stack (100) is detected and stored (310) for a specific time range at a time before the switch-off of the vehicle (200) and/or that a power called up by the fuel cell stack (100) is detected and stored (310) for a specific time range at a time before the switch-off of the vehicle (200), wherein the detected temperature of the fuel cell stack (100) and/or the detected called-up power of the fuel cell stack (100) is taken into account for determining the information at least about the at least one stack portion of the fuel cell stack (100) of the fuel cell system (210).

5. The method according to claim 1,
wherein
after the switch-off of the vehicle (200), the method is carried out several times in succession in a continuous switch-off state of the vehicle (200).

6. The method according to claim 1,
wherein in that
reference data is stored in the vehicle (200) and/or reference data is stored in a cloud, wherein the reference data is used for determining information at least about the at least one stack portion of the fuel cell stack (100) of the fuel cell system (210) based on the applied measurement signal and the detected signal response.

7. The method according to claim 1,
wherein
information about the complete fuel cell stack (100) of the fuel cell system (210) is determined (441) based on the applied measurement signal, and the detected signal response, and/or information is determined (442) for a plurality of stack portions of the fuel cell stack (100) of the fuel cell system (210) in each case based on a respective applied measurement signal and a respective detected signal response.

8. The method according to claim 1,
wherein
instructions are displayed (450) to an occupant of the vehicle (200) depending on the information determined.

9. The method according to claim 1,
wherein
the information determined after the switch-off of the vehicle (200) is taken into account when the vehicle (200) is switched on for starting up the fuel cell system (210), wherein a start-up sequence of the fuel cell system (210) is determined on the basis of the determined information.

10. A vehicle (200), wherein the vehicle (200) is configured to perform a method for determining information about at least one stack portion of a fuel cell stack (100) of a fuel cell system (210) of the vehicle (200) after a switch-off of the vehicle (200) according to claim 1, the vehicle (200) comprising:
a detection device (220) for detecting a switch-off command for switching off the vehicle (200),
a fuel cell system (210) having a fuel cell stack (100), wherein a cathode region (K) of the fuel cell stack (100) can be fluidically blocked off by means of a cathode gas inlet valve and a cathode gas outlet valve, and wherein an anode region (A) of the fuel cell stack (100) can be fluidically blocked off by means of anode gas inlet valve and an anode gas outlet valve,
an electrical load device (230) which can at least be applied to at least one stack portion of the fuel cell stack (100),
an application device (240) for applying an electrical measurement signal to the at least one stack portion of the fuel cell stack (100),
a detection device (250) for detecting a signal response to the applied electrical measurement signal,
a determination device (260) for determining information at least about the at least one stack portion of the fuel cell stack (100) of the fuel cell system (210) based on the applied measurement signal and the detected signal response.

11. (canceled)

12. A non-transitory, computer-readable medium containing instructions that when executed by a computer cause the computer to determine information about at least one stack portion of a fuel cell stack (100) of a fuel cell system (210) of a vehicle (200) after a switch-off of the vehicle (200), by:
detecting (320) a switch-off command for switching off the vehicle (200),
closing (341) a cathode gas inlet valve of the fuel cell system (210) and closing (342) a cathode gas outlet valve of the fuel cell system (210) in order to fluidically block off a cathode region (K) of the fuel cell stack (100) with an air mixture present in the cathode region (K) when the switch-off command is detected,
applying (360) an electrical load device (230) at least to the at least one stack portion of the fuel cell stack (100) in order to reduce the portion of oxygen in the air mixture in the blocked-off cathode region (K) of the fuel cell stack (100), wherein the load device (230) is applied at least until a predefined target voltage is detected (370),
closing (381) an anode gas inlet valve of the fuel cell system (210) and closing (382) an anode gas outlet valve of the fuel cell system (210) in order to fluidically block off an anode region (A) of the fuel cell stack (100) having a fuel mixture present in the anode region (A) when the predefined target voltage is detected.
applying (400) an electrical measurement signal at least to the at least one stack portion of the fuel cell stack (100),
detecting (420) a signal response to the applied electrical measurement signal, and
determining (440) information at least about the at least one stack portion of the fuel cell stack (100) of the fuel cell system (210) based on the applied measurement signal and the detected signal response.

13. (canceled)
